(19) United States
(12) Patent Application Publication
(10) Pub. No.: US 2022/0207923 A1
(43) Pub. Date: Jun. 30, 2022

(54) METHOD FOR IDENTIFYING VEHICLES FOR PARKING MANAGEMENT PURPOSES, DEVICE, SYSTEM, AND ELECTRONIC DEVICE

(71) Applicant: HONGFUJIN PRECISION ELECTRONICS(TIANJIN)CO.,LTD., Tianjin (CN)

(72) Inventors: YU-TE LEE, New Taipei (TW); PO-CHENG CHEN, New Taipei (TW); SHIH CHUN WANG, New Taipei (TW)

(21) Appl. No.: 17/383,840

(22) Filed: Jul. 23, 2021

(30) Foreign Application Priority Data
Dec. 25, 2020 (CN) 202011563325.2

(51) Int. Cl. G07B 15/04; G08G 1/017; G08G 1/14; G06K 9/00

(52) U.S. Cl. CPC G07B 15/04; G08G 1/017; G06K 2209/23; G06K 9/00664; G06K 2209/15; G08G 1/149

(57) ABSTRACT

A method of identifying vehicles for parking management purposes marks out a parking fee paid or unpaid status when a target vehicle exits a parking area, the vehicle information comprising first and second license plate numbers. The first license plate number being entered by a vehicle-user, and the second license plate number being the license plate number as recognized from a first image taken by the parking system when the target vehicle enters the parking area. A third license plate number is taken from an image of the target vehicle when driving out of the parking area. The third license plate number is compared with first or second license plate number, and if the comparison is met, outputting a release instruction to a gate to release the target vehicle. The disclosure also provides an electronic device.

### FIELD

The subject matter herein generally relates to electronics, specifically a parking management method, device, system, and electronic device.

### BACKGROUND

Large-scale parking lots or three-dimensional garages can be set up in large shopping malls, office buildings, communities and other places. The vehicle recognition method of the toll parking lot has gradually changed from traditional sensors to license plate recognition. However, the use of license plate recognition technology has also generated problems.

In an ideal situation, the toll parking system can identify the license plate number with constant accuracy. Because the angle of the car entering or exiting the parking lot is different, the recognition results can be inconsistent or wrong, or letters and numbers on the license plate number may be similar, resulting in recognition errors. When the owner drives the vehicle into the parking lot, the license plate recognition device at the entrance of the parking lot can recognize the license plate number of the vehicle in an incorrect fashion. When the vehicle leaves the parking lot, based on a recognition error, it is impossible to determine whether the vehicle parking has been paid for.

Therefore, an improvement is desired.

### BRIEF DESCRIPTION OF THE DRAWINGS

Implementations of the present disclosure will now be described, by way of embodiments, with reference to the attached figures.

FIG. 1 is a schematic diagram of an embodiment of a parking management system according to the present disclosure.

FIG. 2 is a schematic diagram of an embodiment of a parking management computer according to the present disclosure.

FIG. 3 is a schematic diagram of an embodiment of a parking management device according to the present disclosure.

FIG. 4 is a flowchart of an embodiment of a process for entering a parking lot according to the present disclosure.

FIG. 5 is a flowchart of an embodiment of a parking fee payment process according to the present disclosure.

FIG. 6 is a schematic diagram of an embodiment of a user input interface according to the present disclosure.

FIG. 7 is a schematic diagram of an embodiment of a query interface according to the present disclosure.

FIG. 8 is a schematic diagram of an embodiment of an image collection interface according to the present disclosure.

FIG. 9 is a schematic diagram of an embodiment of the payment amount interface according to the present disclosure.

FIG. 10 is a flowchart of an embodiment of a process of exiting a parking lot according to the present disclosure.

### DETAILED DESCRIPTION

It will be appreciated that for simplicity and clarity of illustration, where appropriate, reference numerals have been repeated among the different figures to indicate corresponding or analogous elements. Additionally, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “comprising” means “including, but not necessarily limited to”; it specifically indicates open-ended inclusion or membership in a so-described combination, group, series, and the like.

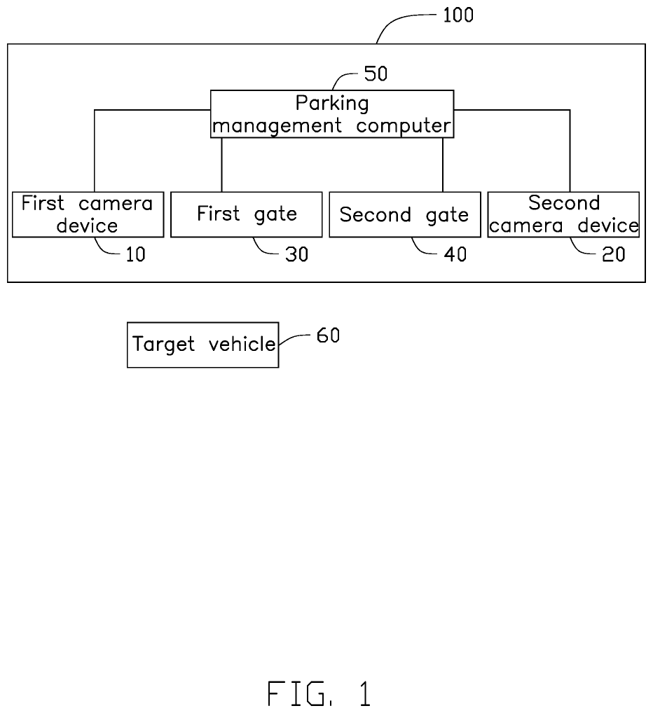

FIG. 1 illustrates a parking management system 100 in accordance with an embodiment of the present disclosure.

The parking management system 100 includes a first camera device 10, a second camera device 20, a first gate 30, a second gate 40, and a parking management computer 50. The parking management system 100 can be applied to parking fee collection places such as parking lots or three-dimensional garages. A software system, such as a parking fee management system, can be installed in the parking management computer 50.

Take a parking lot as an example, the parking lot includes an entrance and an exit, and vehicles enter the parking lot from the entrance and leave the parking lot from the exit. The first camera device 10 and the first gate 30 are at the entrance, and the second camera device 20 and the second gate 40 are at the exit. The first camera device 10 and the second camera device 20 are electrically connected to the parking management computer 50, as are the first gate 30 and the second gate 40. The first gate 30 and the second gate 40 are opened or closed according to the instructions of the parking management computer 50.

When the user drives the target vehicle 60 to the entrance of the parking lot, the first camera device 10 takes an image (first image) of the target vehicle 60, and transmits the first image to the parking management computer 50. The parking management computer 50 performs image recognition on the first image, and can recognize the license plate number, vehicle type, vehicle color, and brand of the vehicle in the first image.

In one embodiment, it is also possible for the first camera device 10 to itself perform image recognition on the first image of the target vehicle 60, to identify the license plate number, vehicle type, vehicle color, and vehicle brand in the first image, the license plate number, vehicle type, vehicle color, and vehicle brand in the recognized first image being then transmitted to the parking management computer 50.

In the embodiment, when performing the image recognition, the recognition of license plate number may be inaccurate. When performing image recognition on the first image, the license plate number as recognized is set as a second license plate number, and a license plate number of the target vehicle 60 as set by a vehicle-user is set as a first license plate number. For example, the user operates the parking payment management system installed by the parking management computer 50, and inputs the first license plate number to the parking payment management system, to find the target vehicle 60 corresponding to the first license plate number.

The user can operate the parking payment management system through a mobile terminal, and complete the payment through the parking payment management system.

When the user drives the target vehicle 60 to the exit of the parking lot, the second camera device 20 captures an image of the target vehicle 60, determines the image captured at the exit as the second image, and transmits the second image to the parking management computer 50.

The parking management computer 50 performs image recognition on the second image, and performs recognition of the license plate number in the second image.

In the embodiment, when performing image recognition on the second image, license plate number as recognized is set as the third license plate number.

In one embodiment, the second camera device 20 may also perform image recognition on the captured second image of the target vehicle 60, to identify the second license plate number in the second image, and the identified second license plate number is transmitted to the parking management computer 50, and the parking management computer 50 determines whether the target vehicle 60 has paid the parking fee or not.

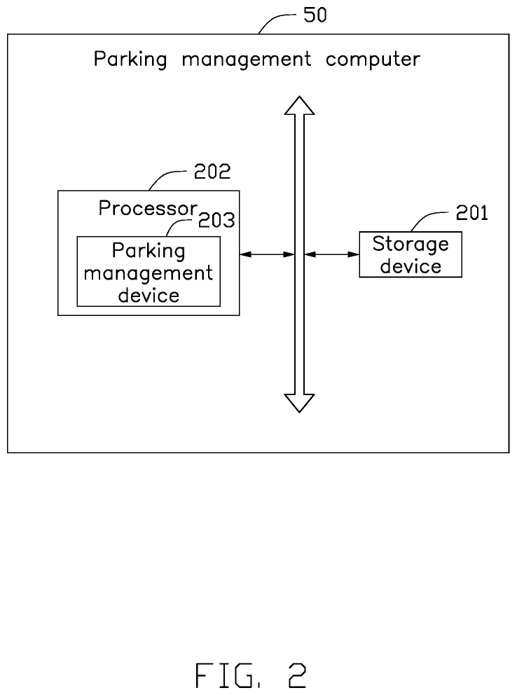

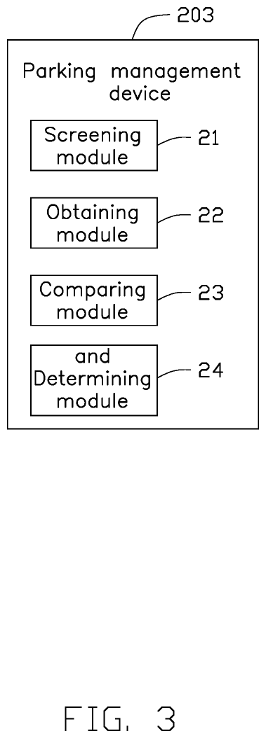

FIG. 2 illustrates a parking management computer 50 in accordance with an embodiment of the present disclosure. The parking management computer 50 is an electronic device. The parking management computer 50 includes a storage device 201, one or more processors 202, and a parking management device 203 stored in the storage device 201 and running on the processor 202. The parking management device 203 may be implemented as a parking management program. When the parking management program is executed by the one or more processors obtaining module 202, the one or more processors 202 implement all the operations executed by the parking management computer 50. Describe the steps in the embodiment of the parking management method, or, when the processor 202 executes the parking management program, the function of each module in FIG. 3 is realized. The one or more modules may be a series of computer program instruction segments capable of completing specific functions, and the instruction segments are used to describe the execution process of the parking management program in the parking management device 203.

Those skilled in the art can understand that the schematic diagram is only an example of the parking management computer 50 and does not constitute a limitation on the parking management computer 50. The parking management computer 50 may include more or fewer components than shown, or a combination of some components, or different components. For example, the parking management computer 50 may also include a communication module, a bus, and the like. The parking management computer 50 communicates with the first camera device 10 and the second camera device 20 through a communication module.

The storage device 201 can be used to store a parking management program. The processor 202 implements various functions of the parking management computer 50 by running or executing the computer program stored in the storage device 201 and calling up data stored in the storage device 201.

The storage device 201 can include random access memory, and can also include non-volatile memory, such as hard disk, memory, plug-in hard disk, smart memory card (Smart Media Card, SMC), Secure Digital (SD) card, flash memory card (Flash Card), at least one disk storage device, flash memory device.

The processor 202 may be a central processing unit (CPU), other general-purpose processors 202, a digital signal processor 202 (DSP), an application specific integrated circuit (ASIC), ready-made programmable gate array (FPGA) or other programmable logic device, discrete gate or transistor logic device, or discrete hardware component. The general-purpose processor 202 can be a microprocessor 202 or the processor 202 can also be any conventional processor obtaining module 202. The processor 202 can use various interfaces and buses to connect various parts of the parking management computer 50.

FIG. 3 illustrates the parking management device 203 in accordance with an embodiment of the present disclosure.

The parking management device 203 includes a screening module 21, an obtaining module 22, a comparing module 23, and a determining module 24.

The screening module 21 is used to mark vehicle information corresponding to the vehicle which has paid toll payment when the target vehicle 60 is detected to drive out of the parking area. The vehicle information includes a first license plate number and a second license plate number, and the first license plate number is the license plate number of the target vehicle 60 input by the user. The second license plate number is the license plate number as recognized based on the first image taken when the target vehicle 60 enters the parking area.

The obtaining module 22 is configured to acquire the third license plate number as recognized according to the second image taken when the target vehicle 60 exits the parking area.

The comparing module 23 is used to compare the third license plate number with the first license plate number or the second license plate number.

The determining module 24 is used to determine that the target vehicle 60 has been paid when the comparison is met, and output a release instruction to release the target vehicle 60.

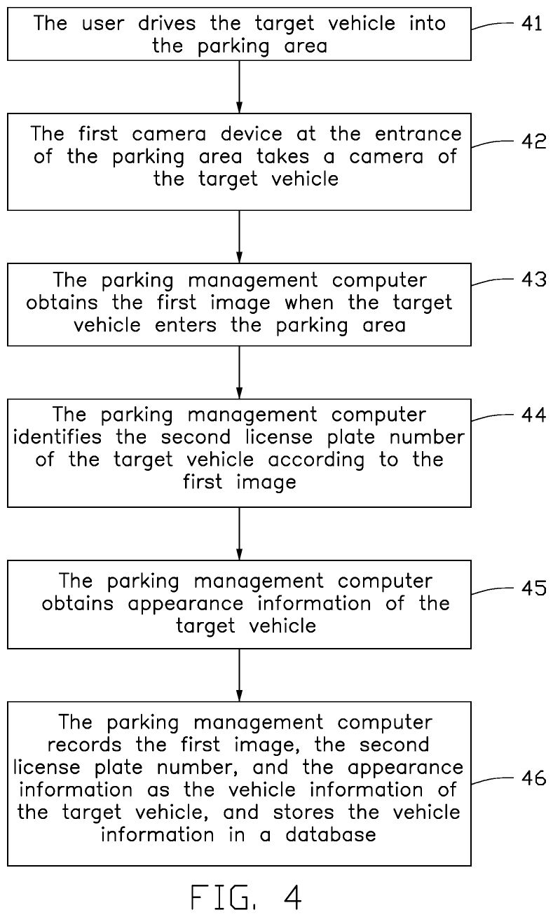

FIG. 4 illustrates a flowchart of a method for entering a parking lot, the method may include the following steps.

In block 41, the user drives the target vehicle 60 into the parking area.

In block 42, the first camera device 10 at the entrance of the parking area takes an image of the target vehicle 60.

In the embodiment, the first camera device 10 is installed at the entrance of the parking area, and the first camera device 10 photographs the vehicles passing in the entrance of the parking area, and the first camera device 10 can photograph the target vehicle 60 at a preset intervals to obtain various pictures of the target vehicle 60.

In block 43, the parking management computer 50 obtains the first image when the target vehicle 60 enters the parking area.

In the embodiment, the parking management computer 50 obtains the first image when the target vehicle 60 enters the parking area. The first image is a picture of the target vehicle 60 taken by the first camera device 10 when the target vehicle 60 enters the parking area. The first image may include multiple pictures of the target vehicle 60.

In block 44, the parking management computer 50 identifies the second license plate number of the target vehicle 60 according to the first image.

In the embodiment, the image of the target vehicle 60 in the first image can be recognized by the first camera device 10 or the parking management computer 50.

At least one picture of the target vehicle 60 in the first image includes the license plate number of the target vehicle 60.

In block 45, the parking management computer 50 obtains information as to appearance of the target vehicle 60. The appearance information includes vehicle type, vehicle color, and brand.

In the embodiment, the first image can be recognized by the first camera device 10 or the parking management computer 50 to identify the vehicle type, vehicle color, and brand of the target vehicle 60.

Comprehensive processing can be performed based on multiple pictures of the target vehicle 60, to determine the vehicle type of the target vehicle 60.

In the embodiment, the vehicle type can indicate that the vehicle is a car, truck, passenger car, utility vehicle, RV, or sports car, the vehicle brand indicates the trademark or factory logo of the vehicle, such as Mercedes-Benz, BMW, Toyota, and the vehicle color recognizes the basic color of the vehicle body.

In block 46, the parking management computer 50 records the first image, the second license plate number, and the appearance information as the vehicle information of the target vehicle 60, and stores the vehicle information in a database.

The parking management computer 50 obtains the appearance information, the first image, and the second license plate number of the target vehicle 60, and records the first image, the second license plate number, and the appearance information as the vehicle information of the target vehicle 60, and stores the vehicle information of the target vehicle 60 in the database.

The database stores the vehicle information of each vehicle entering the parking lot and still within the parking lot.

The vehicle information includes the first image, the second license plate number, the appearance information, and the time when the target vehicle 60 enters the parking lot.

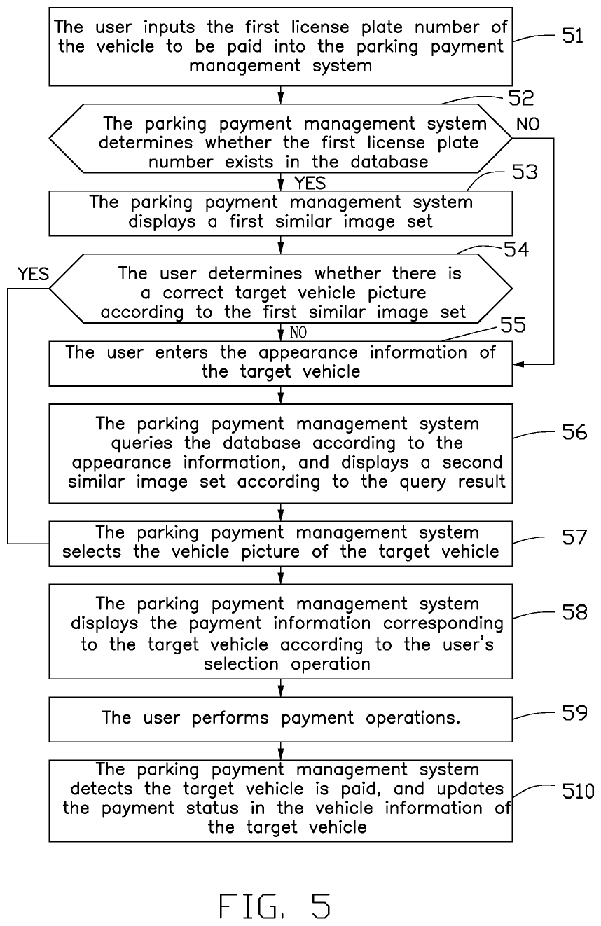

FIG. 5 illustrates a flowchart of a method for parking fee payment, the method may include the following steps.

In block 51, the user inputs the first license plate number of the vehicle to be paid into the parking payment management system.

In the embodiment, the user can input the first license plate number of the vehicle to be paid into the parking payment management system through the mobile terminal or directly through the parking management computer 50.

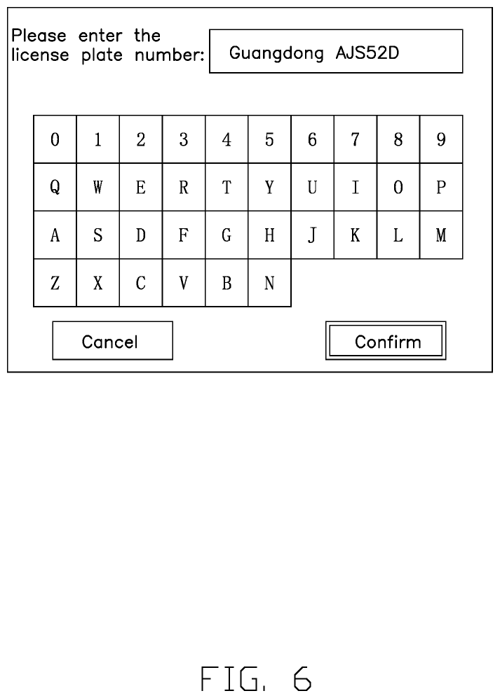

Referring to FIG. 6, an input interface is presented on a display interface of the mobile terminal or the display interface of the parking management computer 50. The input interface includes a prompt box of “please enter the license plate number”, and the entered number can be displayed in the prompt box. The input interface also includes a keyboard, a cancel button control, and a confirm button control. For example, the user enters the first license plate number eg “Guangdong A JS52D” of the vehicle to be paid through the input interface.

In block 52, the parking payment management system determines whether the first license plate number exists in the database. If the first license plate number exists in the database, block 53 is implemented, otherwise block 55 is implemented.

The parking payment management system determines whether the first license plate number is stored in the vehicle information of each vehicle stored in the database.

In block 53, the parking payment management system displays a first similar image set.

The first similar image set includes at least one first vehicle image, wherein the first vehicle image includes a license plate number, and the recognition result of the license plate number is similar to the first license plate number.

In the embodiment, the parking payment management system detects that the first license plate number exists in the database, and the parking payment management system provides multiple vehicle pictures. These vehicle pictures are the first image pictures, the first vehicle pictures are the vehicle pictures including the license plate number, and the license plate number of the first vehicle picture is recognized as similar to the first vehicle license plate number. For example, if the first license plate number is “Guangdong A JS52D”, the license plate number of the first vehicle picture might be recognized as “Guangdong A JS520” or “Guangdong A JS520”.

In the embodiment, an image collection interface is presented on the display interface of the mobile terminal or the display interface of the parking management computer 50. The parking payment management system displays the first similar image set on the image set interface according to the query result.

The image collection interface includes multiple vehicle pictures, and each vehicle picture has a selection button. When the selection button of a picture is clicked, the picture will be selected.

In block 54, the user determines whether there is an image which is correct of target vehicle 60 picture according to the first similar image set. If the there is a correct image, block 57 is implemented, otherwise block 55 is implemented.

In the embodiment, the user can view the first similar image set provided by the parking payment management system through the mobile terminal, or view the first similar image set provided by the parking payment management system through the parking management computer 50. The user browses the picture of the first vehicle in the first similar image set, to confirm whether the first similar image set includes pictures of the target vehicle 60.

In block 55, the user enters the appearance information of the target vehicle 60.

When the user browses the first similar image set, if it is determined that the first vehicle picture does not exist in the first similar image set, the user can input the appearance information of the target vehicle 60 through the mobile terminal or directly through the parking management computer 50.

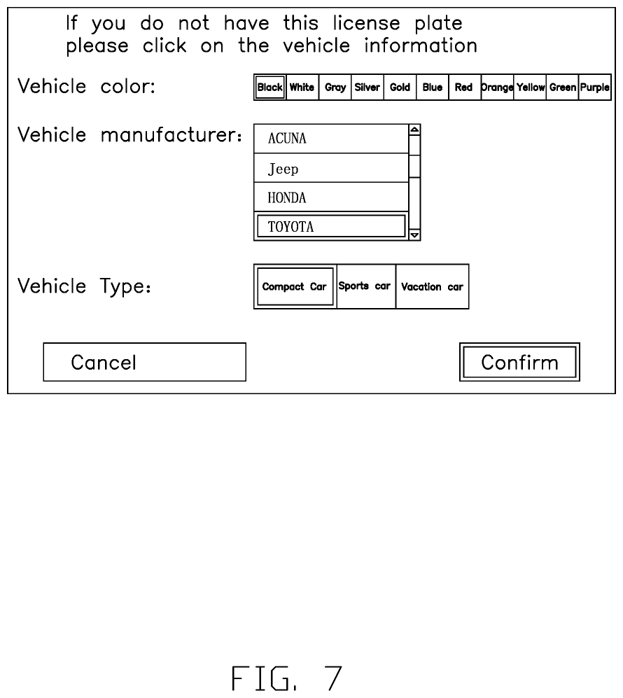

Referring to FIG. 7, a query interface is presented on the display interface of the mobile terminal or the display interface of the parking management computer 50, the query interface includes vehicle color selection control, vehicle brand selection control, vehicle type selection control, cancel button control, and confirmation button control. The user enters the characteristics of the target vehicle 60 through the query interface, such as clicking the blue or other color selection control, clicking the Honda logo selection control, and clicking the sports car vehicle type selection control.

In block 56, the parking payment management system queries the database according to the appearance information, and displays a second similar image set according to the query result.

The second similar image set includes at least one second vehicle picture, wherein the appearance information of the second vehicle picture meets the appearance information of the target vehicle 60.

Having taken a picture of the vehicle when the vehicle enters the parking lot, recognized the appearance information of the vehicle through the picture of the vehicle, and stored the recognized appearance information in the database, the parking payment management system queries the database based on the appearance information to find whether there is a blue Honda sports car in the database.

In the embodiment, the second similar image set is the result of the parking payment management system querying the database based on the appearance information, and the appearance of the second vehicle picture in the second similar image set is identified as being consistent with the appearance of the target vehicle 60.

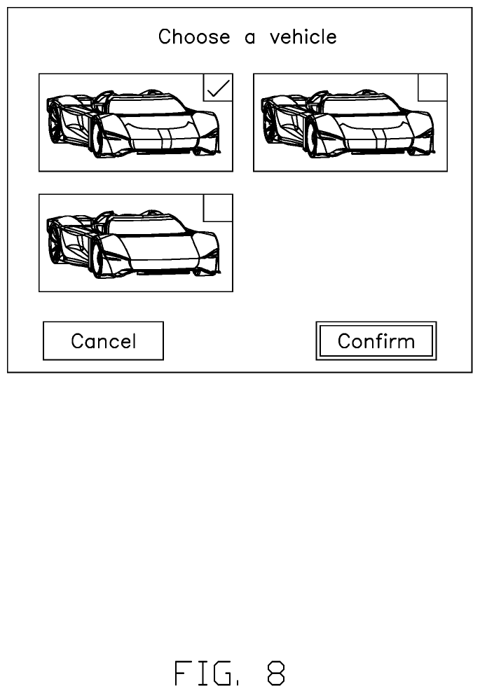

Referring to FIG. 8, an image collection interface is presented on the display interface of the mobile terminal or the display interface of the parking management computer 50. The parking payment management system displays the second similar image set on the image collection interface according to the query result. The image collection interface includes multiple vehicle pictures, and the multiple pictures may be vehicle pictures of different vehicles, or may include pictures of the same vehicle from different sources. Each vehicle picture has a selection button. When the selection button of a picture is clicked, the picture is selected.

In block 57, the parking payment management system selects the vehicle picture of the target vehicle 60.

In the embodiment, the user can select the vehicle picture of the target vehicle 60 in the first similar image set or the second similar image set, and then select the vehicle picture.

In block 58, the parking payment management system displays the payment information corresponding to the target vehicle 60 according to the user's selection operation.

In the embodiment, the user selects the target vehicle 60, and the parking payment management system reads the vehicle information of the target vehicle 60 corresponding to the vehicle picture from the database according to the user's selection operation. The time when the target vehicle 60 entered the parking lot can be read in the vehicle information, and then the parking fee amount that should be paid is calculated.

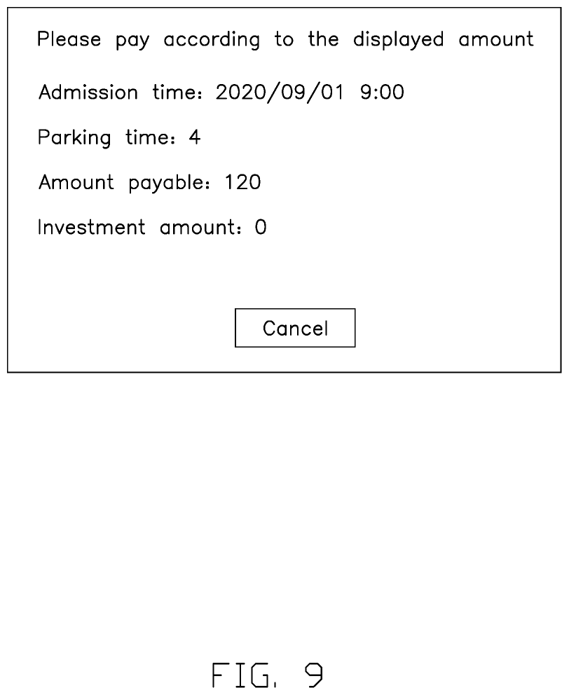

Referring to FIG. 9, a payment amount interface is presented on the display interface of the mobile terminal or the display interface of the parking management computer 50. The parking payment management system calculates the amount due according to the time when the target vehicle 60 enters the parking lot, and display same on the payment amount interface. The payment amount interface includes the time when the target vehicle 60 enters the parking lot, parking time, the amount to be paid, the amount paid, and the cancel button control.

In block 59, the users performs payment operation.

In this embodiment, after the user reads the amount to be paid from the payment amount interface, the user can make the payment by switching to other interfaces or paying the amount through other payment methods.

In block 510, the parking payment management system detects that parking fee of the target vehicle 60 is paid, and updates the payment status in the vehicle information of the target vehicle 60.

In the embodiment, the payment status of each vehicle is recorded in the vehicle information, which defaults to unpaid. When the parking payment management system detects that the target vehicle 60 is paid, the parking payment management system updates the payment status in the vehicle information of the target vehicle 60.

When the user enters the first license plate number but the target vehicle 60 is not found, and the target vehicle 60 is found through appearance information, the first license plate number entered by the user in the vehicle information of the target vehicle 60 is recorded, together with the first license plate number and the second license plate number as license plate number information.

In the embodiment, the vehicle information of the target vehicle 60 will be stored in the database.

The vehicle information includes the first image taken when the vehicle enters the parking lot, the second license plate number of the vehicle recognized according to the first image, the time of entering the parking lot, the first license plate number input by the user, and the recognition obtained according to the first image.

The color of the vehicle, the vehicle type, and the vehicle brand can be identified according to the first image.

In one embodiment, the vehicle information can also record the parking location of the vehicle, and record the parking location of the vehicle according to the cameras installed in the parking garage.

The following Table 1 describes the vehicle information in detail.

TABLE 1

| | | Admission to | | | | | | | |
|---|---|---|---|---|---|---|---|---|---|
| | | identify the | Manually entered | | | | | | |
| | Admission | license plate | license plate | | Vehicle | Vehicle | | Parking | |
| ID | time | number | number | Color | Type | logo | Admission picture | position | Vendor |
| 1 | 2020 Sep. 1 | Guangdong | Guangdong | Blue | Sport | Honda | Blue honda.png | D15 | AA |
| | 9:00 | A JS52O | A JS52D | | car | | | | |

As shown in Table 1, the ID is 1, that is, the ID number of the target vehicle 60 is 1. The entry time of the target vehicle 60 is 9:00 am on Sep. 1, 2020. The second license plate number recognized when the target vehicle 60 enters the parking lot is Guangdong A JS52O. The second license plate number entered by the user for payment inquiry at the beginning is Guangdong A JS52D. The target vehicle 60 is a blue Honda sports car. The entrance picture stores the image taken when the target vehicle 60 enters the parking lot, and the parking position of the target vehicle 60 after entering the parking lot is D15, and the manufacturer of the vehicle is AA.

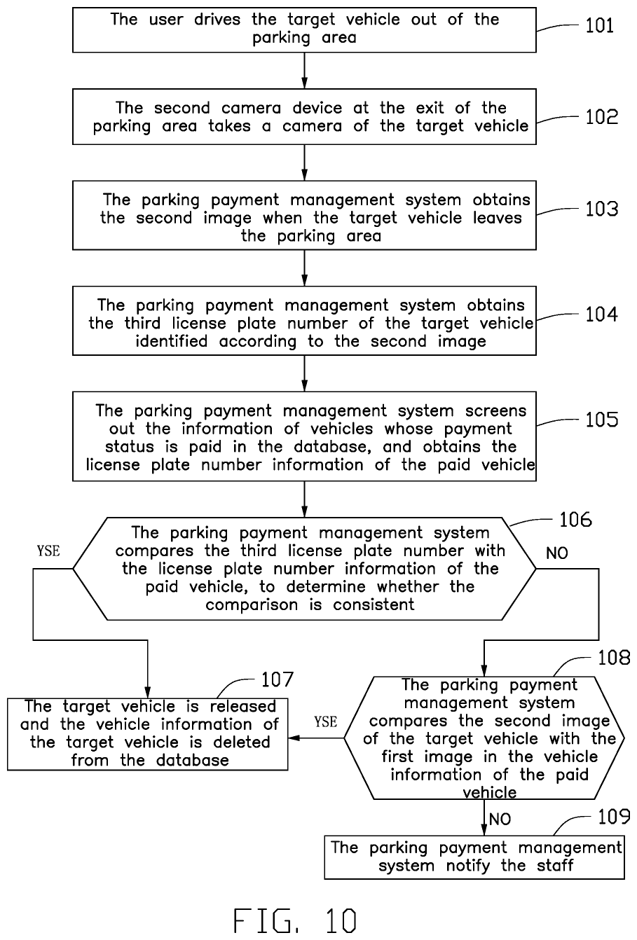

FIG. 10 illustrates a flowchart of a method for leaving the parking lot, the method may include the following steps.

In block 101, the user drives the target vehicle 60 out of the parking area.

In block 102, the second camera device 20 at the exit of the parking area takes an image of the target vehicle 60.

In the embodiment, the second camera device 20 at the exit of the parking lot takes pictures of the vehicle leaving the parking area, to confirm whether parking fee of the vehicle has been paid.

In block 103, the parking payment management system obtains the second image when the target vehicle 60 leaves the parking area.

The second camera device 20 uploads the captured second image to the parking management computer 50, and the parking management system obtains the second image captured by the second camera device 20. The second image may include at least one picture of the vehicle when the target vehicle 60 leaves the parking area.

In block 104, the parking payment management system obtains the third license plate number of the target vehicle 60 identified according to the second image.

In the embodiment, the second camera device 20 may perform image recognition on the second image to obtain the third license plate number, or the parking management computer 50 may perform image recognition on the second image to obtain the third license plate number.

In block 105, the parking payment management system screens out the information of vehicles whose payment status is paid in the database, and obtains the license plate number information of the paid vehicles.

The license plate number information includes the second license plate number or the first license plate number and the second license plate number.

In the embodiment, the parking management system can read the information of the vehicles whose payment status is paid in the database, and obtain the license plate number information of the vehicles whose payment status is paid. The license plate number of some vehicles whose payment status is paid includes only the second license plate number, and the license plate number of some vehicles whose payment status is paid includes the first license plate number and the second license plate number.

In block 106, the parking payment management system compares the third license plate number with the license plate number information of the paid vehicle, to determine whether the comparison is consistent.

In the embodiment, when the third license plate number is consistent with the license plate number information of a certain vehicle of the paid vehicle, it is determined that the comparison is consistent. If the license plate number information only includes the second license plate number, compare the third license plate number with the second license plate number to determine whether the numbers are consistent. If the numbers are consistent, the comparison is consistent. If the license plate number information includes the second license plate number and the first license plate number, for example, compare the second license plate number with the third license plate number to determine whether the numbers are consistent. If the numbers are consistent, the comparison is consistent, or, the first license plate number is compared with the third license plate number to determine whether the numbers are consistent, if the numbers are consistent, the comparison is consistent.

Since the second license plate number is recognized incorrectly, the first license plate number entered by the user is stored to the corresponding vehicle information. When leaving the parking area, the correct first license plate number can be used for comparison and identification, and then the vehicle can be released quickly.

In block 107, the target vehicle 60 is released and the vehicle information of the target vehicle 60 is deleted from the database.

In the embodiment, when the comparison is consistent, it is confirmed that the target vehicle 60 that is about to leave the parking area has already paid the fee, and the release instruction is output to the second gate 40, to allow the second gate 40 to release the target vehicle 60 and delete the vehicle information of the target vehicle 60 from the database.

In block 108, the parking payment management system compares the second image of the target vehicle 60 with the first image in the vehicle information of the paid vehicle.

In the embodiment, the third license plate number is compared with the license plate number information of the paid vehicle recorded in the database. When the number comparison is inconsistent, the first image of the paid vehicle in the database is obtained, and the first image of each paid vehicle is obtained. The parking management system performs image recognition on the vehicle picture in the first image of each paid vehicle and the vehicle picture in the second image of the target vehicle 60, and compares the similarity of the vehicle picture.

In the embodiment, a threshold can be set. When the similarity between the vehicle picture in the second image and the vehicle picture in the first image of the paid vehicle reaches this threshold, it will be determined that the image contrast is consistent.

It is detected that the vehicles whose payment status is paid are A and B, and the first images of two vehicles A and B are acquired. The first image in A includes vehicle picture A1 and vehicle picture A2, and the first image includes vehicle picture B1 and vehicle picture B2. A vehicle picture C in the second image can be compared with vehicle picture A1, vehicle picture A2, vehicle picture B1, and vehicle picture B2 respectively, and it is detected that the similarity between vehicle picture C and vehicle picture A1 reaches the threshold, the image contrast will be determined to be consistent.

When the comparison is consistent, block 107 is executed. In the embodiment, when the comparison is consistent, the vehicle information of the vehicle that has been paid for the comparison is determined as the vehicle information of the vehicle currently leaving the parking area, and the target vehicle 60 has been paid.

In block 109, the parking payment management system notify the staff.

In the embodiment, when the comparison is inconsistent, the vehicle that left the parking area may be unpaid, or it may be paid but there is an error, then a notification message is sent to notify the staff to deal with it.

The embodiment of the present disclosure provides a parking management method.

The parking management method includes: screening out vehicle information of a paid vehicle when a target vehicle is detected to drive out of a parking area; wherein the vehicle information comprises a first license plate number and a second license plate number, the first license plate number is the license plate number of the target vehicle entered by an user, and the second license plate number is the license plate number recognized by a first image taken when the target vehicle enters the parking area; obtaining a third license plate number recognized by a second image taken when the target vehicle is driving out of the parking area; comparing the third license plate number with the first license plate number or the second license plate number, and obtaining a first comparison result; and outputting a release instruction according to the first comparison result to release the target vehicle.

In one embodiment, the parking management method further includes: outputting a release instruction when the third license plate number is consistent with the first license plate number in the vehicle information of the paid vehicle; and outputting a release instruction when the third license plate number is consistent with the second license plate number in the vehicle information of the paid vehicle.

In one embodiment, the parking management method further includes: obtaining a first image of the vehicle information of the paid vehicle when the third license plate number is inconsistent with the first license plate number in the vehicle information of the paid vehicle, and the third license plate number is inconsistent with the second license plate number in the vehicle information of the paid vehicle; comparing the second image with the first image in the vehicle information of the paid vehicle, and obtaining a second comparison result.

In one embodiment, the parking management method further includes: obtaining vehicle type, vehicle color and vehicle logo of the target vehicle when the target vehicle enters the parking area; storing the vehicle type, the vehicle color and the vehicle logo as appearance information; and storing the appearance information to the vehicle information of the target vehicle.

In one embodiment, the parking management method further includes: obtaining the first license plate number entered by the user; and obtaining the appearance information of the target vehicle input by the user when the target vehicle is not found according to the first license plate number; and finding the target vehicle according to the appearance information.

In one embodiment, the parking management method further includes: displaying charging information of the target vehicle when the target vehicle is determined; and updating payment status in the vehicle information of the target vehicle to paid when the user's payment operation is detected.

In the parking management method according to the embodiment of the present disclosure, when the second license plate number is recognized based on the vehicle picture in the first image, when the vehicle information cannot be found based on the first license plate number, or when the found information does not match, and can choose to query through the appearance information of the target vehicle, show the queried vehicle to the user, and the user selects the corresponding vehicle picture. According to the selected vehicle picture, the vehicle information of the vehicle corresponding to the vehicle picture is displayed, and the user can pay according to the payment amount on the vehicle information. Save the first license plate number entered by the user and the first image when the vehicle enters the parking lot in the vehicle information of the vehicle, then when the vehicle leaves the parking lot, it can be compared according to the first license plate number or the second license plate number To confirm whether the vehicle has been paid.

The present disclosure also provides a non-transitory storage medium. Computer instructions are stored on the non-transitory storage medium. The computer instructions may be stored in the storage device 201 or the processor 202, and when executed by one or more processors 202, and the processor is used to implement the parking management method as described in the above method embodiment.

When the modules/units integrated into the parking management system 100 are implemented in the form of software functional units of independent or standalone products, they can be stored in a non-transitory readable storage medium. Based on this understanding, all or part of the processes in the methods of the above embodiments implemented by the present disclosure can also be completed by related hardware instructed by computer-readable instructions. The computer-readable instructions can be stored in a non-transitory readable storage medium. The computer-readable instructions, when executed by the processor, may implement the steps of the embodiments of the foregoing method or methods. The computer-readable instructions include computer-readable instruction codes, and the computer-readable instruction codes can be in a source code form, an object code form, an executable file, or some intermediate form. The non-transitory readable storage medium can include any entity or device capable of carrying the computer-readable instruction code, a recording medium, a U disk, a mobile hard disk, a magnetic disk, an optical disk, a computer memory, or a read-only memory (ROM).

The division of modules described above is a logical function division, the actual implementation of division can be in some other way. In addition, each function module in each embodiment of this application may be integrated into the same processing unit, or the individual modules may be physically present, or two or more modules may be integrated into the same cell.

The above-integrated module can be implemented in the form of hardware, or in the form of hardware plus software function module.

Even though numerous characteristics and advantages of the present technology have been set forth in the foregoing description, together with details of the structure and function of the present disclosure, the disclosure is illustrative only, and changes may be made in the detail, especially in matters of shape, size, and arrangement of the parts within the principles of the present disclosure, up to and including the full extent established by the broad general meaning of the terms used in the claims. It will therefore be appreciated that the exemplary embodiments described above may be modified within the scope of the claims.

What is claimed is:

1. A parking management method comprising:
screening out vehicle information of a paid vehicle when a target vehicle is detected to drive out of a parking area; wherein the vehicle information comprises a first license plate number and a second license plate number, the first license plate number is the license plate number of the target vehicle entered by an user, and the second license plate number is the license plate number recognized by a first image taken when the target vehicle enters the parking area;
obtaining a third license plate number recognized by a second image taken when the target vehicle is driving out of the parking area;
comparing the third license plate number with the first license plate number or the second license plate number, and obtaining a first comparison result; and
outputting a release instruction according to the first comparison result to release the target vehicle.

2. The parking management method according to claim 1, further comprising:
outputting a release instruction when the third license plate number is consistent with the first license plate number in the vehicle information of the paid vehicle; and
outputting a release instruction when the third license plate number is consistent with the second license plate number in the vehicle information of the paid vehicle.

3. The parking management method according to claim 2, further comprising:
obtaining a first image of the vehicle information of the paid vehicle when the third license plate number is inconsistent with the first license plate number in the vehicle information of the paid vehicle, and the third license plate number is inconsistent with the second license plate number in the vehicle information of the paid vehicle;
comparing the second image with the first image in the vehicle information of the paid vehicle, and obtaining a second comparison result.

4. The parking management method according to claim 1, further comprising:
obtaining vehicle type, vehicle color and vehicle logo of the target vehicle when the target vehicle enters the parking area;
storing the vehicle type, the vehicle color and the vehicle logo as appearance information; and
storing the appearance information to the vehicle information of the target vehicle.

5. The parking management method according to claim 4, further comprising:
obtaining the first license plate number entered by the user; and
obtaining the appearance information of the target vehicle input by the user when the target vehicle is not found according to the first license plate number; and
finding the target vehicle according to the appearance information.

6. The parking management method according to claim 5, further comprising:
displaying charging information of the target vehicle when the target vehicle is determined; and
updating payment status in the vehicle information of the target vehicle to paid when the user's payment operation is detected.

7. An electronic device comprising:
a storage device; and
a processor;
wherein the storage device stores one or more programs, which when executed by the processor, cause the processor to:
screen out vehicle information of a paid vehicle when a target vehicle is detected to drive out of a parking area; wherein the vehicle information comprises a first license plate number and a second license plate number, the first license plate number is the license plate number of the target vehicle entered by an user, and the second license plate number is the license plate number recognized by a first image taken when the target vehicle enters the parking area;
obtain a third license plate number recognized by a second image taken when the target vehicle is driving out of the parking area;
compare the third license plate number with the first license plate number or the second license plate number, and obtain a first comparison result; and
output a release instruction according to the first comparison result to release the target vehicle.

8. The electronic device according to claim 7, wherein the processor is further caused to:
output a release instruction when the third license plate number is consistent with the first license plate number in the vehicle information of the paid vehicle; and
output a release instruction when the third license plate number is consistent with the second license plate number in the vehicle information of the paid vehicle.

9. The electronic device according to claim 8, wherein the processor is further caused to:
obtain a first image of the vehicle information of the paid vehicle when the third license plate number is inconsistent with the first license plate number in the vehicle information of the paid vehicle, and the third license plate number is inconsistent with the second license plate number in the vehicle information of the paid vehicle;
compare the second image with the first image in the vehicle information of the paid vehicle, and obtain a second comparison result.

10. The electronic device according to claim 7, wherein the processor is further caused to:
obtain vehicle type, vehicle color and vehicle logo of the target vehicle when the target vehicle enters the parking area;
store the vehicle type, the vehicle color and the vehicle logo as appearance information; and
store the appearance information to the vehicle information of the target vehicle.

11. The electronic device according to claim 10, wherein the processor is further caused to:
obtain the first license plate number entered by the user; and
obtain the appearance information of the target vehicle input by the user when the target vehicle is not found according to the first license plate number; and
find the target vehicle according to the appearance information.

12. The electronic device according to claim 11, wherein the processor is further caused to:
display charging information of the target vehicle when the target vehicle is determined; and
update payment status in the vehicle information of the target vehicle to paid when the user's payment operation is detected.

13. A parking management system comprising:
a first gate;
a second gate;
a first camera device configured for taking a first image of a vehicle when the vehicle entering the parking area;
a second camera device configured for take a second image of the vehicle when the vehicle leaves the parking area; and
a parking management computer configured for receiving the first image and the second image, and controlling the opening and closing of the first gate and the second gate.
